(19) United States
(12) Patent Application Publication
(10) Pub. No.: US 2018/0201781 A1
(43) Pub. Date: Jul. 19, 2018

(54) FLAME RETARDANT RESIN COMPOSITIONS

(71) Applicant: Dow Corning Corporation, Midland, MI (US)

(72) Inventors: Vincent Rerat, Obourg (BE); Fabien Rialland, Bruxelles (BE)

(21) Appl. No.: 15/742,899

(22) PCT Filed: Sep. 8, 2016
(86) PCT No.: PCT/EP2016/071178

§ 371 Date: Jan. 9, 2018

(30) Foreign Application Priority Data
Sep. 9, 2015 (GB) 1516038.5

(51) Int. Cl. C08L 69/00; C08J 3/00; C08J 3/12

(52) U.S. Cl. CPC C08L 69/00; C08J 3/005; C08J 2483/06; C08L 2201/02; C08J 2369/00; C08J 3/12

(57) ABSTRACT

The invention relates to a flame retardant resin composition. The composition comprises: a. A thermoplastic resin and b. A linear polysiloxane comprising at least 2 siloxy units including at least 2 terminal units, wherein at least one terminal unit bears at least one hydroxyl group directly bonded to the Si atom of the terminal unit, and at least one siloxy unit bears at least one aromatic group directly bonded to the Si atom of the unit. The thermoplastic resin is preferably based on an aromatic containing polymer. The composition is able to form a transparent material when solidified for example by cooling at room temperature.

The invention relates to a flame retardant composition, an article or material made of this composition, a process of manufacturing such composition and the use of a linear polysiloxane.

A flame retardant composition can comprise a thermoplastic organic polymer also called thermoplastic resin and at least one flame retardant agent. A flame retardant composition is also called fire resistant composition or FR composition.

A composition is typically a mixture of at least two chemically different compounds. A flame retardant composition typically contains a thermoplastic resin as main component and other ingredients sometimes called additives. The thermoplastic resin typically forms a polymeric matrix. The other ingredients or additives may contain, for example, flame retardant agent(s), filler(s), reinforcing agent, mineral powder, etc. A material designates a compound or a mixture of compounds (a composition). A composition once in cooled, solid form is typically called a finished material. A flame retardant agent is a compound which is able to provide flame retardant properties. For example, said flame retardant agent provides flame retardancy properties when added to a composition containing a thermoplastic resin. The composition containing the flame retardant agent shows increased resistance to burning or other degradation by a flame compared to a composition which does not contain the flame retardant agent. A composition containing a flame retardant agent resists longer to a flame than the same composition but not containing the flame retardant agent. The flame resistance of a material is often estimated by applying a flame to a sample of the material such as in UL94 test further explained herein.

A polymer is a material containing repeating units, typically forming one or more chains. Organo- or organic material is a material containing carbon (C) atoms. An organic polymer is a polymer containing repeating C-C bonds. An organic polymer is sometimes defined as a polymer in which at least 50% of the atoms in the polymer backbone are carbon atoms. A thermoplastic polymer is a polymer which has thermoplastic properties. A material has thermoplastic properties when it shows plastic deformation upon heating. A thermoplastic polymer is solid at ambient temperature (25° C.).

A siloxane or polysiloxane or silicone is a material containing at least 2 siloxy units bonded together through a Si—O—Si link. A polysiloxane has at least 2 terminal siloxy units. The other units if present are called non-terminal units. A terminal unit is said to be end-capped when Si—OH function is engaged into a Si—O—SiR3 link where R is a organic moiety and can be identical or different for example an hydroxyl group (Si—OH) is replaced by trialkyl for example trimethyl silyl. The polysiloxane can be a polymer based on silicon containing repeating units.

A polysiloxane may comprise mono-functional (M), and/or di-functional (D), and/or tri-functional (T) and/or tetra-functional siloxy (Q) siloxy unit(s). The Si atom of a M unit is bonded to 1 O atom. The Si atom of a D unit is bonded to 2 O atoms. The Si atom of a T unit is bonded to 3 O atoms. The Si atom of a Q unit is bonded to 4 O atoms. A M unit typically has the formula R₃SiO_{1/2}. A D unit typically has the formula R₂SiO_{2/2}. A T unit typically has the formula RSiO_{3/2}. A Q unit typically has the formula SiO_{4/2}. Each R is a substituent (also called a group) linked to the silicon atom. Where the unit contains more than one R, the Rs can be the same or can be different on one silicon atom. Furthermore the Rs can be different on different silicon atoms. R is typically an organic substituent i.e. a substituent containing at least one C atom, preferably several C atoms forming C—C bonds. R can be alkyl, alkenyl, hydroxyl, alkoxy, aromatic.

For example, R can be selected from substituted and unsubstituted monovalent hydrocarbon groups and is exemplified by alkyl groups such as methyl, ethyl, and propyl, typically each alkyl group contains from 1 to 10 carbon atoms; alkenyl groups such as vinyl, allyl, butenyl, pentenyl, cyclohexenyl and hexenyl; aryl groups such as phenyl; and aralkyls such as 2-phenylethyl. The alkyl groups may be substituted with in particular with fluoro groups such that one or more alkyl groups may be trifluoroalkyl groups, e.g. trifluoropropyl groups or perfluoroalkyl groups. The alkyl groups may be substituted with a halogen atom, a cyano group, a phosphorus atom, hydrocarbon group, hydrocarbyl group, etc A polysiloxane may be linear, and mainly composed of M and D units. When composed of only D units, the polysiloxane is cyclic or linear. Linear polysiloxane may contain some degree of branching, that is, at least 1 T unit or a at least 1 Q unit. Polysiloxane “resins” contain predominantly T and/or Q units.

An aromatic group typically contains a conjugated organic cycle. A common aromatic group is the phenyl group (—C₆H₅).

The percentages by weight mentioned in the following description are, unless indicated differently, based on the weight of the total composition i.e. the composition containing the polymer and all other ingredients.

EP 0918073B1 describes flame retardant compositions comprising (A) a synthetic resin containing an aromatic ring in a molecule, typically an aromatic polycarbonate resin or aromatic epoxy resin, and (B) a minor amount of organosiloxane containing phenyl and alkoxy radicals, represented by the following average compositional formula (1):

R¹ₘR²ₙSi(OR³)ₚ(OR)_{q}O_{(4-m-n-p-q)/2}

wherein R¹ is phenyl, R² is a monovalent hydrocarbon radical of 1 to 6 carbon atoms excluding phenyl, R³ is a monovalent hydrocarbon radical of 1 to 4 carbon atoms, and m, n, p and q are numbers satisfying 0.5≤m≤2.0, 0≤n≤0.9, 0.42≤p 2.5, 0 q 0.35, and 0.92 m+n+p+q 2.8.

U.S. Pat. No. 6,284,824B1 describes a flame retardant polycarbonate composition comprising (a) 100 parts by weight polycarbonate resin and (b) 1 to 10 parts by weight of an organopolysiloxane consisting essentially of 50 up to 90 mol % of siloxane T units represented by R¹SiO_{3/2} and 10 to 50 mol % of siloxane units D represented by R²R³SiO_{2/2} wherein R¹, R², and R³ are independently substituted or unsubstituted monovalent hydrocarbon groups having 1 to 10 carbon atoms, phenyl being contained in an amount of at least 80 mol % of the entire organic substituents.

WO 2005/078012 A2 describes the composition of a curable fire retardant material. The composition is composed of a monomer, oligomer or polymer, such as a base resin typically liquid at 25° C. and a compatible siloxane which is miscible with the base resin. Optionally, the composition contains an additional fire retardant additive. The mixture needs to be in liquid form at 25° C. The components are then cured i.e. reacted, so that the polymeric material contains polysiloxane units amongst the resin units.

EP1288262A2 describes a flame-retardant composition comprises 100 wt. parts of resin component (A) and 0.1-10 wt. parts of silicone compound (B). Component (A) comprises 50-100 wt. % of aromatic polycarbonate resin, 0-50 wt. % of styrene-based resin and 0-50 wt. % of aromatic polyester resin. Compound (B) has silicon hydride group content of 0.1-1.2 mols/100 g and aromatic group (1) content of 10-70 wt. %.

EP2314643 describes a thermoplastic polyester resin composition containing thermoplastic polyester resin, phosphinate, organosiloxane and colemanite. The organosiloxane typically contains predominantly T units. Transparency of the final product is not sought.

EP10262204 describes flame retardant compositions containing polycarbonate resin or aromatic epoxy resin and a minor amount of an organopolysiloxane containing phenyl radicals and monofunctional siloxane units wherein the contents of alkoxy radicals and hydroxyl radicals are each set at less than 2% by weight.

It is an object of the present invention to provide a flame retardant resin composition which fulfills at least one of the following properties and preferably more than one:
Transparency of the finished material and/or
Ease of manufacturing and/or
Increased flame resistance of the composition compared to similar composition free of polysiloxane and/or
Increased anti-dripping effect of the finished material compared to similar material free of polysiloxane.

The present invention provides one or more of the following:
1. A flame retardant resin composition comprising:
   a. A thermoplastic resin and
   b. A linear polysiloxane comprising at least 2 siloxy units including at least 2 terminal units, wherein at least one terminal unit bears at least one hydroxyl group directly bonded to the Si atom of the terminal unit, and at least one siloxy unit bears at least one aromatic group directly bonded to the Si atom of the unit.
2. The flame retardant composition as defined above wherein each terminal unit bears at least one hydroxyl group directly bonded to the Si atom of the terminal unit.
3. The flame retardant composition as defined above wherein the non terminal siloxy units are free of alkoxy or hydroxyl group substituents directly attached to the Si atom.
4. The flame retardant resin composition as defined above wherein at least one of the siloxy units bears an alkyl group directly bonded to the Si atom of said siloxy unit, preferably a methyl or propyl group.
5. The flame retardant composition as defined above wherein the non terminal siloxy units contain only alkyl and/or aromatic substituents.
6. The flame retardant composition as defined above wherein one of the terminal units is end-capped M unit, preferably a trimethylsiloxy unit.
7. The flame retardant composition as defined above wherein at least 30 mol % of the siloxy units bears at least one aromatic group.
8. The flame retardant composition as defined above wherein at least 50 mol % of the siloxy units bears at least one aromatic group, and preferably at least 80 mol % of the siloxy units bears at least one aromatic group.
9. The flame retardant composition as defined above wherein at least 90 mol % of the siloxy units bears at least one aromatic group, and preferably 100 mol % of the siloxy units bears at least one aromatic group.
10. The flame retardant resin composition as defined above wherein the polysiloxane contains less than 100 siloxy units, preferably from 2 to 50 siloxy units.
11. The flame retardant resin composition as defined above wherein each terminal Si atom bears one hydroxyl group directly bonded to the Si atom.
12. The flame retardant resin composition as defined above wherein the aromatic group comprises a phenyl group.
13. The flame retardant resin composition as defined above wherein the composition contains an additional flame retardant additive, preferably an alkaline salt such as e.g. sulfonate salt.
14. The flame retardant resin composition as defined above wherein the thermoplastic resin ranges from 30 to 99.8 weight percent calculated on the total weight of the composition.
15. The flame retardant resin composition as defined above wherein the linear polysiloxane ranges from 0.2 to 50 weight percent calculated on the total weight of the composition.
16. The flame retardant resin composition as defined above wherein the thermoplastic resin is based on an aromatic containing polymer.
17. The flame retardant resin composition as defined above wherein the thermoplastic resin contains a polycarbonate, aromatic polyester, polystyrene, aromatic polyamide (polyaramide), polysulfone, ABS (acrylonitrile butadiene styrenic polymer), aromatic polyacrylate or polyether(ether)ketone polymer or any blend of these polymers.
18. The flame retardant resin composition as defined above wherein the resin contains a polycarbonate polymer or a polycarbonate/ABS blend.
19. The flame retardant resin composition as defined above wherein the composition forms a transparent material when solidified for example by cooling at room temperature.
20. The flame retardant resin composition as defined above wherein the materialformed has a total transmittance Tt of at least 80%.
21. The flame retardant resin composition as defined above further containing a filler such as calcium carbonate or a reinforcing filler such as glass fibers.
22. An article containing a flame retardant composition as defined above.
23. A process of manufacturing a flame retardant resin composition comprising mixing: a molten thermoplastic resin with a fluid linear polysiloxane comprising at least 2 siloxy units including at least 2 terminal siloxy units, wherein at least one terminal unit bears at least one hydroxyl group directly bonded to the Si atom of the terminal unit, and at least one siloxy unit bears at least one aromatic group directly bonded to the Si atom of the unit.
24. The process as defined above, wherein the mixture of molten thermoplastic resin and linear polysiloxane is extruded in the form of pellets.
25. Use of a linear polysiloxane comprising at least 2 siloxy units including at least 2 terminal siloxy units, wherein at least one terminal unit bears at least one hydroxyl group directly bonded to the Si atom of the terminal unit, and at least one siloxy unit bears at least one aromatic group directly bonded to the Si atom of the unit, as additive in a flame retardant thermoplastic resin.

In one embodiment, the polysiloxane used in the present invention has a linear structure. In one embodiment, the polysiloxane has only D and M units and is not cyclic. Preferably, the polysiloxane is substantially free of T units, free of M units and/or free of Q units. In one embodiment, the polysiloxane contains less than 10 mol % preferably less than 5 mol %, preferably less than 1 mol % T or Q units. Preferably, the linear polysiloxane comprises only D units. It has been observed that the presence of T and Q units may decrease the miscibility of the polysiloxane in the polymeric matrix and may decrease the transparency of the final product as well as the flame retardancy performance. In one embodiment, the poysiloxane used in the invention has bis phenyl or phenyl/methyl substituents on siloxy units. It is also important that at least one, and preferably 2, terminal siloxy unit(s) bear(s) an hydroxyl substituent directly linked to the Si atom.

The polysiloxane is often made of a mixture of at least 2 different polysiloxanes. In one embodiment, the polysiloxane has a viscosity of at least 30 cSt at 25° C. In one embodiment, the polysiloxane has a viscosity of up to 10000 cSt at 25° C. In one embodiment, viscosity of the polysiloxane is comprised between 50 cSt and 1000 cSt at 25° C.Viscosity is often measured with glass capillary test method. Values of kinematic viscosity in cSt (or mm²/s) are close to dynamic viscosity (mPa·s or cP) as density of polysiloxanes is ≈1.

The polysiloxane is typically free of silicon hydride groups Si—H. Such groups may lead to unwanted production of gas (such as H₂) when the final composition is put in presence of humidity and heat.

The polysiloxane is typically free of alkoxy groups on siloxy units. Such groups may lead to unwanted production of alcohol such as methanol when the final composition is under certain conditions for example in case of heated and humid environment.

The polysiloxane is typically free of hydroxyl groups except those hydroxyl groups directly linked to the Si atom of the terminal unit(s). Hydroxyl groups along the siloxane chain may lead to unwanted reaction of the final composition in certain conditions.

The polysiloxane preferably contains at least 2%, more preferably at least 3% by weight of hydroxyl groups.

It has been found that the addition of polysiloxane as described above, especially phenyl/methyl silanol linear siloxane fluid, in thermoplastic resin allows to reach excellent FR properties of the finished material especially for anti-dripping effect.

The flame retardant composition or material can contain one or more of the following additives/agents:
Mineral Reinforcement/Fillers: improve stiffness, surface hardness, cost reduction for example calcium carbonate, talc, silica, mica, kaolin, titanium oxide, carbon black, metals, ceramic powder, borosilicate and/or clays such as wollastonite, fibres such as glass fibres, carbon fibres, metal fibres, natureal fibres or ceramic fibres
Dyes and Pigments: color & appearance—for example organic pigment or dye when transparency is important for example azo, indigoid, triphenylmethane, anthraquinone, hydroquinone or xanthine dye
Antioxidants & stabilizers: delay/prevent oxidation during processing/application
UV Stabilizers: interfere with light-induced degradation, weathering
Blowing Agents: production of foams, weight reduction
Lubricants: improvement in processing, release properties
Coupling Agents: impart compatibility between polymer & additives
Antistats/Conductives: prevent electrostatic discharge, improve conductivity
Antimicrobials: prevent microbiological attack and property degradation
Impact Modifiers: enhance toughness of material to impact
Optical Brighteners: enhance appearance, off-set yellow color
Flame Retardants: prevent ignition & flame spread, prolong escape time
Heat resistant polymeric additive for example polytetrafluorethylene (PTFE)
Polymeric additive for example butyl methacrylate styrenic polymer beads.

The composition according to the invention may further comprise other flame retardant additive such as but not limited to inorganic flame retardants such as metal hydrates or zinc borates, metal hydroxides such as magnesium hydroxide, antimony oxide or aluminum hydroxide, phosphorus such as organic phosphorous (e.g. phosphate, phosphonates, phosphine, phosphinate, phosphine oxide, phosphonium compounds, phosphites, etc.) such as ammonium polyphosphate, boron phosphate, nitrogen containing additives, carbon based additives such as expandable graphite or carbon nanotubes, nanoclays, red phosphorous, silica, aluminosilicates or magnesium silicate (talc), silicone gum, sulfur based additives such as sulfonated salt, alkaline fluorinated sulfonate, ammonium sulfamate, potassium diphenyl sulfone sulfonate (KSS) used as trans-estherification catalyst or thiourea derivatives, polyols like pentaerythritol, dipentaerythritol, tripentaerythritol or polyvinylalcohol, red phosphorous, silicon-containing additives such as silica, aluminosilicate or magnesium silicate (talc), silicone gums, sulfur-containing additives, such as potassium diphenyl sulfone sulfonate (known as KSS). In one embodiment, the composition is free of halogenated additives. In a preferred embodiment, the composition is free of organic phosphorus and halogen-containing compound. Examples of fillers which can be used in the thermoplastic composition include talc, silica, calcium carbonate, mica, kaolin, titanium oxide, carbon black, metals, ceramic powder, borosilicate and/or clays such as wollastonite. Fillers can for example be present at 0 or 5 up to 50 or 95% by weight based on the weight of the thermoplastic resin.

The composition can be manufactured by moulding, for example by injection moulding, extrusion or blow moulding, to form a variety of products such as products for building, construction, electric or electronic applications. For example finished materials can be used for side walls, screens or LED lamps protection often requiring VO rating. The polysiloxane can conveniently be incorporated in the thermoplastic resin by extrusion, for example in a mono screw or twin screw extruder. If polysiloxane is a liquid, the twin screw extruder may be equipped with a liquid injection line additives and also a side feeder for feeding the thermoplastic resin and any powder form co-additives such as an auxiliary flame retardant or mineral powder. The thermoplastic resin and co-additives may be physically mixed before introduction to the side feeder. It may be convenient to premix the thermoplastic resin with any fibrous reinforcing agent such as glass fibres before mixing with other ingredients. When forming injection moulded articles from the composition, the polysiloxane can be incorporated in the thermoplastic resin by extrusion as described above and the extrudate can be pelletized and then moulded in an injection moulding machine. The polysiloxane can be added to pellets of the thermoplastic resin or injected in the molten resin for example right after melting zone. Manufacturing temperature of the apparatus is typically between 180 and 300° C.

### EXAMPLES

The material was prepared through a mixing process using a twin screws co-rotating extruder (TSE 20/40) from Brabender. The extruder was characterized by a D=20 and UD=40.

The extrusion process was performed using the conditions described in table 1 below:

TABLE 1

| | T1 | T2 | T3 | T4 | T5 | T6 |
|---|---|---|---|---|---|---|
| Temperature (° C.) | 50 | 285 | 280 | 275 | 260 | 260 |

| Screw speed (rpm) | 200 |
|---|---|
| Throughput (kg/h) | 2.0 |
| Die size (mm) | 4 mm |

The silicone based additive was added in 10D through a direct liquid injection pump system. This is allowing the introduction of the additive directly in the molten polymer and avoids the use of a dry blend of the polycarbonate pellets with the silicone additive. The polycarbonate (PC) used was a Lexan 141 R, injection grade (MFI 10.5; 300° C.; 1.2 kg).

The polycarbonate pellets were dried for/during 2 hrs at 120° C. prior to compounding.

Extruded pellets of the different formulations were dried 2 hrs at 120° C. ENGEL press 200/80 Tech. has been used in order to inject test specimens of finished material. UL94 were measured on specimens having a 1.5 mm thickness. UL 94, the Standard for Safety of Flammability of Plastic Materials for Parts in Devices and Appliances testing is a plastics flammability standard released by Underwriters Laboratories of the USA. The standard classifies plastics according to how they burn in various orientations and thicknesses. Classification ranges from lowest (least flame-retardant) to highest (most flame-retardant).

A specimen is placed vertically. 2 burners applications of 10 seconds are applied at the bottom of the specimen. Specimen rating is based on burning behavior of the material and classified as follow:
HB: slow burning on a horizontal specimen; burning rate <76 mm/min for thickness <3 mm or burning stops before 100 mm
V-2 burning stops within 30 seconds on a vertical specimen; drips of flaming particles are allowed.
V-1: burning stops within 30 seconds on a vertical specimen; drips of particles allowed as long as they are not inflamed.
V-0: burning stops within 10 seconds on a vertical specimen; drips of particles allowed as long as they are not inflamed.

Tests were conducted on 12.7 cm×1.27 cm injected specimens of the minimum approved thickness—1.5 mm

The optical performances were measured on 1.5 mm thickness optical disks using UV-Visible-NIR Spectrophotometer Lambda 950. Procedure B with spectrophotometer was used to assess optical performances according to ASTM D-1003.

Mechanical performances especially deformation resistance (E-mod, F Max and Elongation at break) were tested according to ISO 527-2 measurement standards.

The requirements for a UL94 rating of V-0 are that the specimens must not burn with flaming combustion for more than 10 s after application of the test flame. The total flaming combustion time must not exceed 50 s for the 5 flame applications. The burning and glowing time after the second flame application must not exceed 30 s. The specimens must not burn with flaming or glowing combustion up to the holding clamp and must not drip flaming particles that ignite the dry absorbent surgical cotton located 300 mm below. The requirements for a UL94 rating of V-1 are that the specimens must not burn with flaming combustion for more than 30 s after application of the test flame. The total flaming combustion time must not exceed 250 s for the 5 flame applications. The burning and glowing time after the second flame application must not exceed 60 s. The specimens must not burn with flaming or glowing combustion up to the holding clamp and must not drip flaming particles that ignite the dry absorbent surgical cotton located 300 mm below. The halogen-free and phosphorus-free flame retardant polyamide compositions of the present invention are capable of achieving a UL94 rating of V-I for specimens of thickness 1.5 mm. Material description:

Table 2 below describes the silicone based additives used.

TABLE 2

| | Viscosity | RI | OH | OH | |
|---|---|---|---|---|---|
| | (cst) | (25° C.) | (w %) | (Mol %) | comments |
| Silicone 1 | 500 | 1.545 | 3.25-5 | 0.19-0.294 | Low OH |
| Silicone 2 | 500 | 1.545 | 5.2-7.2 | 0.305-0.423 | High OH |
| Silicone 3 | 500 | 1.538 | 0 | 0 | SiMe3 end- |
| | | | | | capped |

Silicones 1, 2 and 3 are phenyl/methyl silicones.

Silicones 1, 2 and 3 have less than 50 siloxy units.

Silicone 1 and 2 are described as phenyl/methyl linear siloxanes, having a viscosity of 500 cst (25° C.), a refractive index of 1.545 and silanol content comprised between 3.25 and 7.2.

On the contrary, Silicone 3 has the same structure vs Silicone 1 at the exception that the Silanols have been blocked by means of trimethyl silyl groups.

Following formulations were performed, coded as “Form” in Table 3:

TABLE 3

| | | Siloxane | —OH | |
|---|---|---|---|---|
| formu- | | content | content | Sulfonate salt. |
| lations | siloxane | (wt %) | Mol % | (KSS-arichem) |
| Form 1 | N.A. | 0 | 0 | N.A. |
| Form 2 | Silicone 1 | 2 | 0.0038-0.00588 | 0 |
| Form 3 | Silicone 1 | 2 | | 0.3 |
| Form 4 | Silicone 1 | 2 | | 0.6 |
| Form 5 | Silicone 1 | 4 | 0.0076-0.01176 | 0 |
| Form 6 | Silicone 1 | 4 | | 0.3 |
| Form 7 | Silicone 1 | 4 | | 0.6 |
| Form 8 | Silicone 2 | 2 | 0.0061-0.00846 | 0 |
| Form 9 | Silicone 2 | 2 | | 0.3 |
| Form 10 | Silicone 2 | 2 | | 0.6 |
| Form 11 | Silicone 2 | 4 | 0.0122-0.0169 | 0 |
| Form 12 | Silicone 2 | 4 | | 0.3 |
| Form 13 | Silicone 2 | 4 | | 0.6 |
| Form 14 | Silicone 3 | 4 | 0 | 0 |
| Form 15 | N.A | 0 | 0 | 0.3 |

Form 1 represents the neat polycarbonate reference, without any additive. Forms 2-7 contain the phenyl/methyl siloxane having lower OH content (Silicone 1) while Forms 8-13 contains the Phenyl/methyl siloxane having a higher OH content (Silicone 2). Form 14 represents counter example using phenyl/methyl siloxane where the OH end-groups have been blocked by trimethylsilyl group (Silicone 3). Form 14 will proof the important concept of having hydroxyl groups on terminal units both for flame retardancy and transparency properties of the finished material. Forms 3-4-6-7-9-10-12 and 13 are representing the use of the silicone additives together with (alkaline salts) sulfonate salts. Form 15 represents a non silicone classical formulation containing KSS (0.6 wt %) and PTFE (0.2 wt %), typically used as anti-drip system for PC.

Table 4 below gives the different results

TABLE 4

| | | | | Optical | | Mechanical | | |
|---|---|---|---|---|---|---|---|---|
| | | | | ASTM | | ISO 527-2 | | |
| | UL-94 1.5 mm | | | D-1003 | | | | Elongation |
| Sample | | | t2 | Tt | Haze | E- | F | @ break |
| ID | ranking | t1(s) | (s) | (%) | (%) | mod | Max | (%) |
| Form 1 | V-2 | 10.0 | 11.4 | 89 | 0 | 2400 | 64 | 106 |
| Form 2 | V-0 | 3.0 | 1.4 | 87 | 2.4 | 2350 | 65 | 55 |
| Form 3 | V-0 | 2.8 | 3.4 | 87 | 2.2 | 2350 | 66 | 55 |
| Form 4 | V-0 | 2.4 | 4.4 | 87 | 2.8 | 2360 | 66 | 70 |
| Form 5 | V-0 | 3.2 | 2.4 | 87 | 1.4 | 2390 | 67 | 71 |
| Form 6 | V-0 | 2.4 | 2.0 | 87 | 2.2 | 2390 | 68 | 48 |
| Form 7 | V-0 | 2.8 | 1.0 | 85 | 2.5 | 2410 | 68 | 46 |
| Form 8 | V-2 | 7.2 | 1.4 | 87 | 3.2 | 2450 | 67 | 15 |
| Form 9 | V-0 | 4 | 4.8 | 87 | 2.2 | 2400 | 65 | 40 |
| Form 10 | V-2 | 4.2 | 5.8 | 87 | 2.7 | 2380 | 66 | 47 |
| Form 11 | V-0 | 2.6 | 5.2 | 87 | 2.7 | 2410 | 68 | 30 |
| Form 12 | V-2 | 2 | 2.8 | 87 | 2.1 | 2460 | 68 | 29 |
| Form 13 | V-0 | 2.6 | 4.6 | 87 | 3 | 2470 | 68 | 35 |
| Form 14 | V-2 | 10 | 9 | 45 | 95 | 2100 | 63 | 8 |
| Form 15 | V-0 | 8.6 | 7 | 81 | 16 | 2320 | 63 | 76 |

From the above table, it is seen that the use of the phenyl/methyl Si—OH terminated siloxane was able to deliver the UL-94 V0 rating at 1.5 mm thickness while maintaining good material transparency with very low to no haze. From those results, it can be seen that some discrepancies based on —OH levels where 0.0038-0.01176 mol % delivers more robust V-0 results on 1.5 mm thickness. In general, higher flaming time were obtained for the higher —OH formulations (Forms 8→13).

Form 14 clearly shows the importance of the Si—OH functionalities both in terms of flame retardancy performances but also for polymer compatibility as demonstrated both by the UL-94 rating, the optical data and the mechanical performances. Form 14 showed indeed a systematic V-2 classification with a lot of burning drips. Silicone 3 delivered completely milky compound which delivered only 45% Tt and a very high haze of 95%. This is due to a bad compatibility between the 2 phases which is immediately observed in the Elongation at break of this finished material, going down to 8% only.

Finally, Form 15 using typically formulation with KSS and PTFE delivered expected V-0 rating but faced issues of transparency with a haze of 16% and a decrease of the Tt down to 81%.

1. A flame retardant resin composition comprising:
a. a thermoplastic resin and
b. a linear polysiloxane comprising at least 2 siloxy units including at least 2 terminal units, wherein at least one terminal unit bears at least one hydroxyl group directly bonded to the Si atom of the terminal unit, and at least one siloxy unit bears at least one aromatic group directly bonded to the Si atom of the unit.

2. The flame retardant composition according to claim 1 wherein each terminal unit bears at least one hydroxyl group directly bonded to the Si atom of the terminal unit.

3. The flame retardant composition according to claim 1 wherein the non terminal siloxy units are free of alkoxy or hydroxyl group substituents.

4. The flame retardant resin composition according to claim 1 wherein at least one of the siloxy units bears an alkyl group directly bonded to the Si atom of said siloxy unit, wherein the alkyl group is a methyl or propyl group.

5. The flame retardant composition according to claim 1 wherein the non terminal siloxy units contain only alkyl and/or aromatic substituents.

6. The flame retardant composition according to claim 1 wherein one of the terminal units is end-capped with a trimethylsiloxy unit.

7. The flame retardant composition according to claim 1 wherein at least 30 mol % of the siloxy units bears at least one aromatic group.

8. The flame retardant composition according to claim 1 wherein at least 50 mol % of the siloxy units bears at least one aromatic group or at least 80 mol % of the siloxy units bears at least one aromatic group.

9. The flame retardant composition according to claim 1 wherein at least 90 mol % of the siloxy units bears at least one aromatic group or 100 mol% of the siloxy units bears at least one aromatic group.

10. The flame retardant resin composition according to claim 1 wherein the polysiloxane contains less than 100 siloxy units or from 2 to 50 siloxy units.

11. The flame retardant resin composition according to claim 1 wherein each terminal Si atom bears one hydroxyl group directly bonded to the Si atom.

12. The flame retardant resin composition according to claim 1 wherein the aromatic group comprises a phenyl group.

13. The flame retardant resin composition according to claim 1 wherein the composition contains an alkaline salt.

14. The flame retardant resin composition according to claim 1 wherein the thermoplastic resin ranges from 30 to 99.8 weight percent calculated on the total weight of the composition.

15. The flame retardant resin composition according to claim 1 wherein the linear polysiloxane ranges from 0.2 to 50 weight percent calculated on the total weight of the composition.

16. The flame retardant resin composition according to claim 1 wherein the thermoplastic resin is based on an aromatic containing polymer.

17. The flame retardant resin composition according to claim 1 wherein the thermoplastic resin contains a polycarbonate, aromatic polyester, polystyrene, aromatic polyamide (polyaramide), polysulfone, ABS (acrylonitrile butadiene styrenic polymer), aromatic polyacrylate or polyether(ether)ketone polymer or any blend of these polymers.

18. The flame retardant resin composition according to claim 1 wherein the resin contains a polycarbonate polymer or a polycarbonate/ABS blend.

19. The flame retardant resin composition according to claim 1 wherein the composition forms a transparent material when solidified for example by cooling at room temperature.

20. The flame retardant resin composition according to claim 19 wherein the material formed has a total transmittance Tt of at least 80%.

21. The flame retardant resin composition according to claim 1 further containing a filler such as calcium carbonate or a reinforcing filler such as glass fibers.

22. An article containing a flame retardant composition as defined in claim 1.

23. A process of manufacturing a flame retardant resin composition comprising mixing: a molten thermoplastic resin with a fluid linear polysiloxane comprising at least 2 siloxy units including at least 2 terminal siloxy units, wherein at least one terminal unit bears at least one hydroxyl group directly bonded to the Si atom of the terminal unit, and at least one siloxy unit bears at least one aromatic group directly bonded to the Si atom of the unit.

24. The process according to claim 23, wherein the mixture of molten thermoplastic resin and linear polysiloxane is extruded in the form of pellets.

25. Use of a linear polysiloxane comprising at least 2 siloxy units including at least 2 terminal siloxy units, wherein at least one terminal unit bears at least one hydroxyl group directly bonded to the Si atom of the terminal unit, and at least one siloxy unit bears at least one aromatic group directly bonded to the Si atom of the unit, as additive in a flame retardant thermoplastic resin.
